(19) United States
(12) Patent Application Publication
(10) Pub. No.: US 2006/0201770 A1
(43) Pub. Date: Sep. 14, 2006

(54) Electromagnetic clutch for compressor

(75) Inventors: Tomohiro Yamaguchi, Isesaki-shi (JP); Takahiro Ohta, Isesaki-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Sanden Corporation, Iseaki-shi (JP)

(21) Appl. No.: 11/369,835

(22) Filed: Mar. 8, 2006

(30) Foreign Application Priority Data
Mar. 9, 2005 (JP) 2005-065424

(51) Int. Cl. F16D 27/112

(52) U.S. Cl. 192/84.961

(57) ABSTRACT

The present invention provides an electromagnetic clutch for compressor which can reduce magnetic resistance between a core ring and a rotor without reducing a gap in the radial direction between the core ring and the rotor. In the present invention, since an opposite face portion 16b opposed to the other end face in the axial direction of the pulley portion 11a of a rotor 11 is provided on a core ring 16 with a gap through which magnetism can communicate so as to form a flow of the magnetism from the opposite face portion 16b to the pulley portion 11a and the other end face in the axial direction of the pulley portion 11a and the opposite face portion 16b of the core ring 16 are formed perpendicularly to the axial center of the rotor 11, respectively, the opposite face portion 16b of the core ring 16 and the other end face in the axial direction of the pulley portion 11a are not brought into contact with each other even if deflection of the pulley portion 11a or displacement of axial center is generated, by which a gap between the opposite face portion 16b and the pulley portion 11a can be reduced.

### BACKGROUND OF THE INVENTION

1. Field of the Invention

The present invention relates to an electromagnetic clutch for compressor used in an air conditioner for vehicle, for example.

2. Description of the Related Art

As this type of electromagnetic clutch, an electromagnetic clutch is known which is provided with a core ring arranged coaxially with a rotational axis of a compressor, an electromagnetic coil provided on the core ring, an annular rotor rotatably supported on an outer circumferential face of a support portion extending in the axial direction from a compressor body via a bearing and formed surrounding the core ring from the radial direction, a pulley portion formed on an outer circumferential face side of the rotor, an armature arranged opposite to one end face in the axial direction of the rotor, a hub connected to the rotational axis of the compressor and a plate spring for connecting the armature and the hub to each other, for transmitting a torque of the rotor to the rotational axis of the compressor by attracting the armature to the one end face in the axial direction of the rotor with a magnetic force of the electromagnetic coil (See Japanese Patent Publication 08-247171, for example).

In order to improve high-speed rotation and to reduce the size and weight of the compressor, reduction of an outer diameter of the rotor is in demand in the above electromagnetic clutch. However, in order to reduce the outer diameter of the rotor, the core ring and the electromagnetic coil should be formed smaller in the radial direction, and a magnetomotive force is lowered by just that much. Therefore, it is necessary to reduce a gap in the radial direction between the core ring and the pulley portion of the rotor to make magnetic resistance smaller, but since the pulley portion of the rotor is easy to be deflected in the radial direction by a tension of a belt, if the gap in the radial direction between the core ring and the pulley portion is made smaller, there is a fear that the pulley portion will touch the core ring. Therefore, the gap between the core ring and the pulley portion can not be made sufficiently small. Also, in the conventional electromagnetic clutch, a fixed ring is welded on one end face of the core ring in the axial direction for supporting the core ring to the compressor body, and it is difficult to align the core ring to the axial center of the fixed ring with accuracy due to displacement at welding. From this point, the gap between the core ring and the pulley portion should be kept large.

### SUMMARY OF THE INVENTION

The present invention was made in view of the above problems and it has an object to provide an electromagnetic clutch for compressor which can reduce magnetic resistance between a core ring and a rotor without reducing a gap in the radial direction between the core ring and the rotor.

In order to achieve the above described object, the present invention is, in an electromagnetic clutch for compressor provided with a core ring arranged coaxially with a rotational axis of a compressor, an electromagnetic coil provided on the core ring, an annular rotor rotatably supported on an outer circumferential face of a support portion extending in the axial direction from a compressor body via a bearing and formed surrounding the core ring from the radial direction, a pulley portion formed on an outer circumferential face side of the rotor, and an armature arranged opposite to one end face in the axial direction of the rotor and rotated integrally with the rotational axis of the compressor, in which a torque of the rotor is transmitted to the armature by attracting the armature to the one end face in the axial direction of the rotor by a magnetic force of the electromagnetic coil, an opposite face portion is provided on the core ring opposite to the other end face in the axial direction of the pulley portion with a gap through which magnetism can communicate and the other end face of the pulley portion in the axial direction and the opposite face portion of the core ring are formed perpendicularly to the axial center of the rotor, respectively.

By this, since the opposite face portion of the core ring is opposed to the other end face in the axial direction of the pulley portion of the rotor with the gap through which the magnetism can communicate, a flow of magnetism from the opposite face portion to the rotor is formed. And since the other end face in the axial direction of the pulley portion and the opposite face portion of the core ring are formed perpendicularly to the axial center of the rotor, respectively, the opposite face portion of the core ring and the other end face in the axial direction of the pulley portion are not brought into contact with each other even in the case of rotor deflection or displacement of the axial center. Therefore, the gap between the opposite face portion and the pulley portion can be made smaller, and the magnetic resistance between the core ring and the pulley portion can be reduced by the gap in the axial direction without reducing the gap in the radial direction between the core ring and the pulley portion. By this, since the core ring and the electromagnetic coil can be formed smaller in the radial direction, the outer diameter of the rotor can be made smaller by just that much, which can realize high-speed rotation and reduced size and weight of the compressor.

### BRIEF DESCRIPTION OF THE DRAWINGS

FIG. 1 is a side sectional view of an electromagnetic clutch showing a first embodiment of the present invention;

FIG. 2 is a front view of the electromagnetic clutch;

FIG. 3 is a schematic side view of an essential part showing a flow of magnetism;

FIG. 4 is a side sectional view of an essential part of the electromagnetic clutch showing a second embodiment of the present invention;

FIG. 5 is a schematic side view of an essential part showing a flow of magnetism;

FIG. 6 is a side sectional view of an essential part of the electromagnetic clutch showing a third embodiment of the present invention;

FIG. 7 is a schematic side view of an essential part showing a flow of magnetism;

FIG. 8 is a side sectional view of an essential part of the electromagnetic clutch showing a fourth embodiment of the present invention;

FIG. 9 is a side sectional view of an essential part of the electromagnetic clutch showing a fifth embodiment of the present invention;

FIG. 10 is a side sectional view of an essential part of the electromagnetic clutch showing a sixth embodiment of the present invention;

FIG. 11 is a side sectional view of an essential part of the electromagnetic clutch showing a seventh embodiment of the present invention;

FIG. 12 is a side sectional view of an essential part of the electromagnetic clutch showing a eighth embodiment of the present invention;

FIG. 13 is a side sectional view of an essential part of the electromagnetic clutch showing a ninth embodiment of the present invention;

FIG. 14 is a side sectional view of an essential part of the electromagnetic clutch showing a tenth embodiment of the present invention; and

FIG. 15 is a side sectional view of an essential part of the electromagnetic clutch showing an eleventh embodiment of the present invention.

### DESCRIPTION OF THE PREFERRED EMBODIMENTS

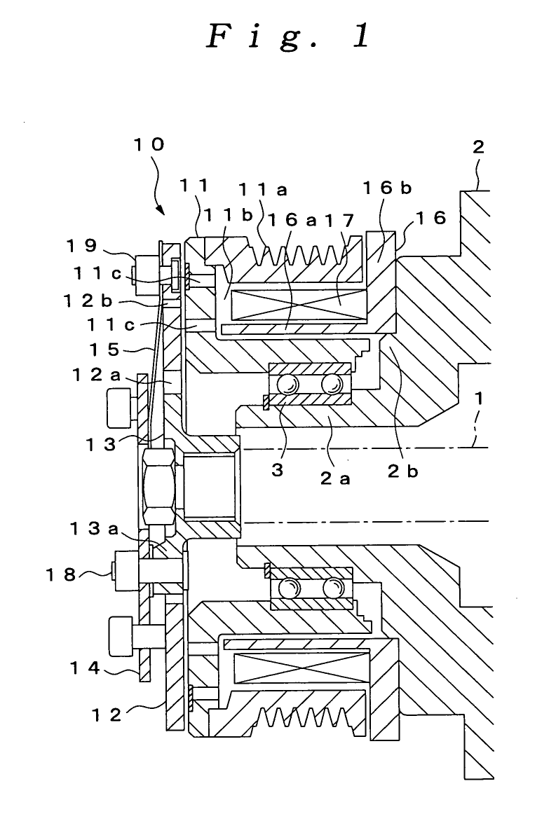

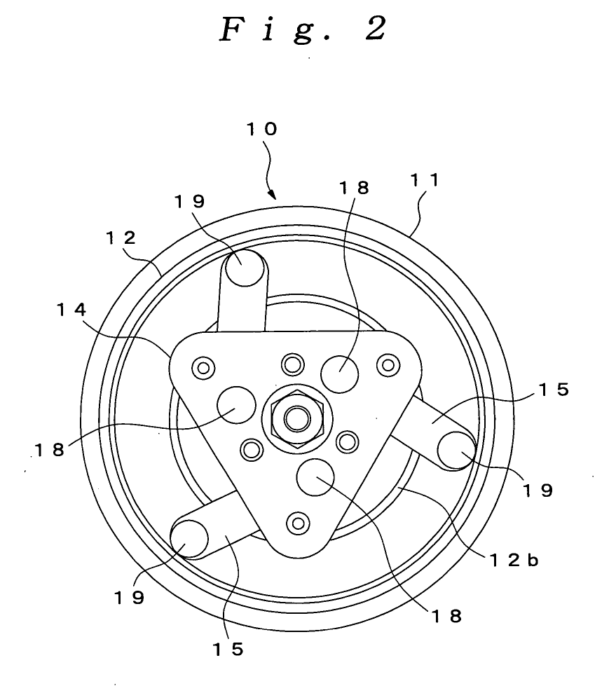

FIGS. 1 to 3 show a first embodiment of the present invention.

An electromagnetic clutch 10 shown in these FIGS. is provided with a rotor 11 arranged coaxially with a rotational axis 1 of a compressor, an armature 12 arranged opposite to one end face in the axial direction of the rotor 11, a hub 13 connected to the rotational axis 1 of the compressor, a plate 14 mounted to the hub 13, a plurality of plate springs 15 for connecting the hub 13 and the armature 12 to each other, a core ring 16 arranged coaxially with the rotor 11 and an electromagnetic coil 17 provided on the core ring 16.

The rotor 11 is made of a metal magnetic material such as iron formed in the annular state, and a pulley portion 11a around which a multistage belt, not shown, is wound is provided on its outer circumferential face. The rotor 11 is rotatably supported by a cylindrical support portion 2a extending in the axial direction from a compressor body 2 via a bearing 3 and its inner circumferential face is fixed on the outer ring side of the bearing 3. One end face of the rotor 11 is opposed to the armature 12, and an annular recess portion 11b is provided inside thereof surrounding the inner circumferential face of the core ring 16 and the outer circumferential face of the electromagnetic coil 17 so as to open on the other end face side. On one end face of the rotor 11 in the axial direction is provided an elongated hole 11c extending in the circumferential direction with an interval in the radial direction of the rotor 11, and each of the elongated holes 11c is made to communicate to the respective recess portions 11b. Also, the other end face in the axial direction of the pulley portion 11a is formed perpendicularly with respect to the axial center of the rotor 11 and its outer diameter is formed larger by a dimension L in the radial direction than the belt wound portion.

The armature 12 is made of a metal magnetic material such as an iron formed into a disk state, and its one end face in the axial direction is opposed to the one end face of the rotor 11 with a slight gap. At the center of the armature 12, a circular opening 12a through which the hub 13 is inserted is provided, and the inner diameter of the opening 12a is formed larger than the outer diameter of the hub 13. Also, in the armature 12, an elongated hole 12b extending in the circumferential direction is provided, and the elongated hole 12b is located between each of the elongated holes 11c of the rotor 11.

The hub 13 has its one end side in the axial direction coupled to the rotational axis 1 of the compressor, and on the other end side is provided a flange 13a located within the opening 12a of the armature 12.

The plate 14 is arranged on the other end face side of the armature 12 and has its plural points in the circumferential direction coupled to the flange 13a of the hub 13 with a coupling pin 18.

Each of the plate springs 15 is formed in the straight state, and its one end side is coupled to the flange 13a of the hub 13 together with the plate 14 by the coupling pin 18. Also, the other end side of each of the plate springs 15 is coupled to the armature 12 with a coupling pin 19.

The core ring 16 is made of an annularly formed metal magnetic material and its one end side in the axial direction is arranged within the recess portion 11b of the rotor 11. On the inner circumferential face side of the core ring 16 is provided an inner circumferential face portion 16a opposed in the radial direction to the circumferential face of the recess portion 11b inside in the radial direction, and a gap A1 is formed in the radial direction between the inner circumferential face portion 16a and the circumferential face of the recess portion 11b. And on the other end side in the axial direction of the core ring 16 is provided with an opposite face portion 16b opposed in the axial direction to the other end face in the axial direction of the pulley portion 11a of the rotor 11. The opposite face portion 16b is formed in the flange state extending in the radial direction perpendicularly with respect to the axial center of the rotor 11, and a gap A2 is formed in the axial direction between the opposite face portion 16b and the other end face in the axial direction of the rotor 11. An engagement portion 2b having an outer diameter almost equal to the inner diameter of the inner circumferential face portion 16a is provided on the compressor body 2, and when the inner circumferential face portion 16a is engaged with the engagement portion 2b, movement of the core ring 16 in the radial direction is regulated.

The electromagnetic coil 17 is made of a wire-wound conductor applied with insulation coating and arranged on the outer circumferential face side of the core ring 16 so that it is opposed in the radial direction to the circumferential face outside in the radial direction in the recess portion 11b of the rotor 11. In this case, a gap A3 is formed in the radial direction between the electromagnetic coil 17 and the circumferential face on the outside of the recess portion 11b.

In the above constituted electromagnetic clutch 10, when a power of an engine, not shown, is inputted into the pulley portion 11a of the rotor 11 through the belt, the rotor 11 is rotated coaxially with the rotational axis 1 of the compressor. At that time, when the conductivity through the electromagnetic coil 17 is stopped, the rotor 11 and the armature 12 are held with an interval between them by each of the plate springs 15, and the rotor 11 idles with respect to the armature 12, and the torque of the rotor 11 is not transmitted to the armature 12. If the electromagnetic coil 17 is energized at this time, the electromagnetic coil 17 generates a magnetic force, and the armature 12 is attracted to the rotor 11 side by the electromagnetic force of the electromagnetic coil 17. By this, the armature 12 is attracted to one end face in the axial direction of the rotor 11, the torque of the rotor 11 is transmitted to the armature 12, and the torque of the armature 12 is transmitted to the rotational axis 1 of the compressor through the hub 13.

Also, in the above described electromagnetic clutch 10, when the magnetic force is generated by the electromagnetic coil 17, the magnetism flows through the core ring 16, the rotor 11 and the armature 12 as shown by a dotted line in FIG. 3. That is, the magnetism generated by the electromagnetic coil 17 flows from the opposite face portion 16b of the core ring 16 to the other end face in the axial direction of the pulley portion 11a of the rotor 11 through the gap A2, and then, flows to the armature 12 from the one end face in the axial direction of the rotor 11. At that time, the magnetic force flowing through the rotor 11 and the armature 12 flows alternately through the rotor 11 and the armature 12 so as to avoid each of the elongated holes 11c and 12b and then, flows from the rotor 11 to the inner circumferential face portion 16a of the core ring 16 through the gap A1. Also, the opposite face portion 16b of the core ring 16 and the other end face in the axial direction of the pulley portion 11a are formed extending in the radial direction perpendicularly to the axial center of the rotor 11, and even if the pulley portion 11a of the rotor 11 is deflected by the tension of the belt in the radial direction or displacement is generated in the radial direction between the core ring 16 and the axial center of the rotor 11, the opposite face portion 16b of the core ring 16 and the other end face in the axial direction of the pulley portion 11a are not brought into contact with each other.

In this way, according to this embodiment, by providing the opposite face portion 16b in the core ring 16 so as to be opposed to the other end face in the axial direction of the pulley portion 11a of the rotor 11 with the gap A2 through which the magnetic force can communicate, the flow of the magnetism from the opposite face portion 16b to the pulley portion 11a of the rotor 11 is formed. And since the other end face in the axial direction of the pulley portion 11a and the opposite face portion 16b of the core ring 16 are formed perpendicularly with respect to the axial center of the rotor 11, respectively, even if deflection of the pulley portion 11a or displacement of the axial center is generated, the opposite face portion 16b of the core ring 16 and the other end face in the axial direction of the pulley portion 11a are not brought into contact with each other, and the gap A2 between the opposite face portion 16b and the pulley portion 11a can be reduced. By this, even without reducing each of the gaps A1 and A3 in the radial direction between the core ring 16 and the rotor 11, the magnetic resistance between the core ring 16 and the pulley portion 11a of the rotor 11 can be reduced by the gap A2 in the axial direction, and the core ring 16 and the electromagnetic coil 17 can be formed smaller in the radial direction. Therefore, the outer diameter of the rotor 11 can be reduced by that amount, by which high-speed rotation and reduction in size and weight of the compressor can be realized.

Also, since the core ring 16 is formed with only its inner circumferential face portion 16a opposed in the radial direction to the rotor 11 and the electromagnetic coil 17 is arranged on the outer circumferential face side of the core ring 16 so as to be opposed to the rotor 11 in the radial direction, the electromagnetic coil 17 and the rotor 11 can be brought closer to each other in the radial direction without interposing a part of the core ring 16 between them, by which the diameter of the rotor 11 can be further reduced.

Moreover, since the pulley portion 11a of the rotor 11 is formed so that its outer diameter is larger in the radial direction by the dimension L than the belt winding portion, the strength in the radial direction of the other end side in the axial direction of the pulley portion 11a can be enhanced, and such an advantage is realized that the pulley portion 11a is not deflected easily even if the thickness of the belt winding portion in the radial direction of the pulley portion 11a is reduced.

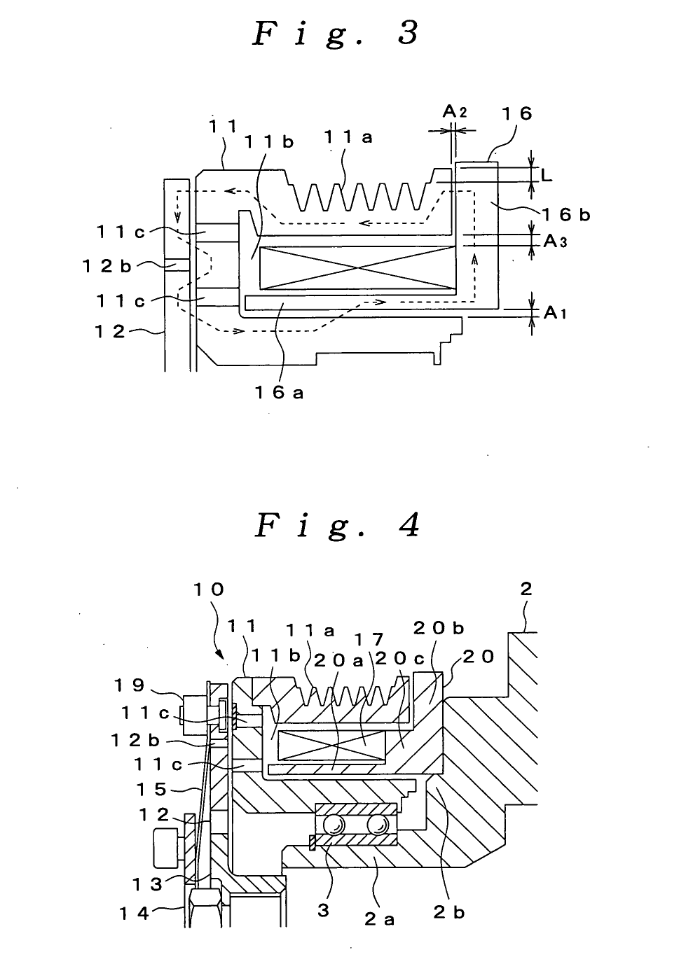

FIGS. 4 and 5 show a second embodiment of the present invention. The components equivalent to those in the above described embodiment are shown with the same reference numerals.

A core ring 20 in this embodiment has, as in the first embodiment, an inner circumferential face portion 20a opposed in the radial direction to the circumferential face inside in the radial direction of the recess portion 11b and a first opposite face portion 20b opposed in the axial direction to the other end face in the axial direction of the pulley portion 11a of the rotor 11, in which the gap A1 is formed in the radial direction between the inner circumferential face portion 20a and the circumferential face of the recess portion 11b, and the gap A2 is formed in the axial direction between the first opposite face portion 20b and the other end face in the axial direction of the rotor 11. Also, a second opposite face portion 20c opposed in the radial direction to a part of the circumferential face outside in the radial direction of the recess portion 11b is provided on the other end side in the axial direction of the core ring 20, and a gap A4 is formed in the radial direction between the second opposite face portion 20c and the circumferential face of the recess portion 11b. In this case, the second opposite face portion 20c is formed extending toward the one end side in the axial direction from inside in the radial direction of the first opposite face portion 20b, and the electromagnetic coil 17 is arranged on one end side in the axial direction of the second opposite face portion 20c.

In this embodiment, when the magnetic force is generated by the electromagnetic coil 17, the magnetism flows, as shown by a dotted line in FIG. 5, to the core ring 20, the rotor 11 and the armature 12. That is, the magnetism generated by the electromagnetic coil 17 flows from the first and the second opposite face portions 20b and 20c of the core ring 20 to the pulley portion 11a of the rotor 11 through the gap A2 and the gap A4, respectively, and then, flows from the one end face in the axial direction of the rotor 11 to the armature 12 and from the rotor 11 to the inner circumferential face portion 20a of the core ring 20 through the gap A1.

According to this embodiment, since the second opposite face portion 20c is provided on the other end side in the axial direction of the core ring 20 so as to be opposed in the radial direction to a part of the circumferential face outside in the radial direction in the recess portion 11b of the rotor 11, not only the flow of magnetism in the axial direction from the first opposite face portion 20b to the pulley portion 11a of the rotor 11 but also the flow of the magnetism in the radial direction from the second opposite face portion 20c to the rotor 11 can be formed, by which the magnetic resistance can be further reduced. In this case, as in the first embodiment, since the gap A2 on the first opposite face portion 20b side can be formed smaller, the gap A4 on the second opposite face portion 20c side can be formed larger so that contact between the second opposite face portion 20c and the rotor 11 can be surely prevented.

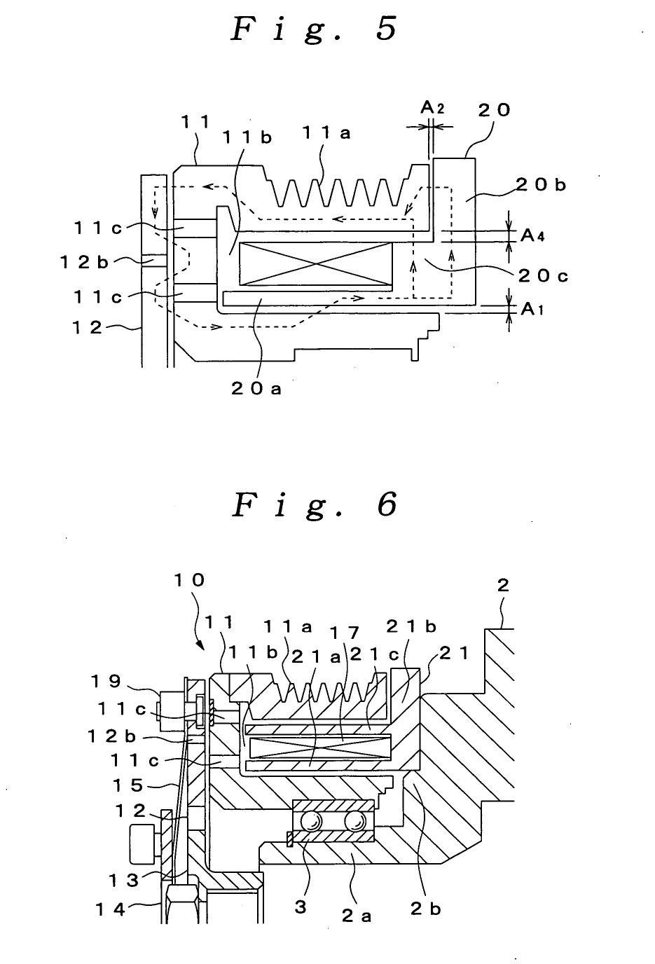

FIGS. 6 and 7 show a third embodiment of the present invention. The components equivalent to those in the above described embodiment are shown with the same reference numerals.

A core ring 21 in this embodiment has, as in the first embodiment, an inner circumferential face portion 21a opposed in the radial direction to the circumferential face inside in the radial direction of the recess portion 11b and an opposite face portion 21b opposed in the axial direction to the other end face in the axial direction of the pulley portion 11a of the rotor 11, in which the gap A1 is formed in the radial direction between the inner circumferential face portion 21a and the circumferential face of the recess portion 11b, and the gap A2 is formed in the axial direction between the opposite face portion 21b and the other end face in the axial direction of the rotor 11. Also, an outer circumferential face portion 21c opposed in the radial direction to the circumferential face outside in the radial direction of the recess portion 11b is provided on the outer circumferential face side of the core ring 21, and a gap A5 is formed in the radial direction between the inner circumferential face portion 21a and the circumferential face of the recess portion 11b.

In this embodiment, when the magnetic force is generated by the electromagnetic coil 17, the magnetism flows, as shown by a dotted line in FIG. 7, to the core ring 21, the rotor 11 and the armature 12. That is, the magnetism generated by the electromagnetic coil 17 flows from the opposite face portions 21b and the outer circumferential face portion 21c of the core ring 21 to the pulley portion 11a of the rotor 11 through the gap A2 and the gap A5, respectively, and then, flows from the one end face in the axial direction of the rotor 11 to the armature 12 and from the rotor 11 to the inner circumferential face portion 21a of the core ring 21 through the gap A1.

According to this embodiment, since the outer circumferential face portion 21c is provided on the outer circumferential face side of the core ring 21 so as to be opposed in the radial direction to the circumferential face outside in the radial direction in the recess portion 11b, not only the flow of magnetism in the axial direction from the opposite face portion 21b to the pulley portion 11a of the rotor 11 but also the flow of the magnetism in the radial direction from the outer circumferential face portion 21c to the pulley portion 11a of the rotor 11 can be formed, by which the magnetic resistance can be further reduced. In this case, as in the first embodiment, since the gap A2 on the opposite face portion 21b side can be formed smaller, the gap A5 on the outer circumferential face portion 21c side can be formed larger so that contact between the outer circumferential face portion 21c and the rotor 11 can be surely prevented.

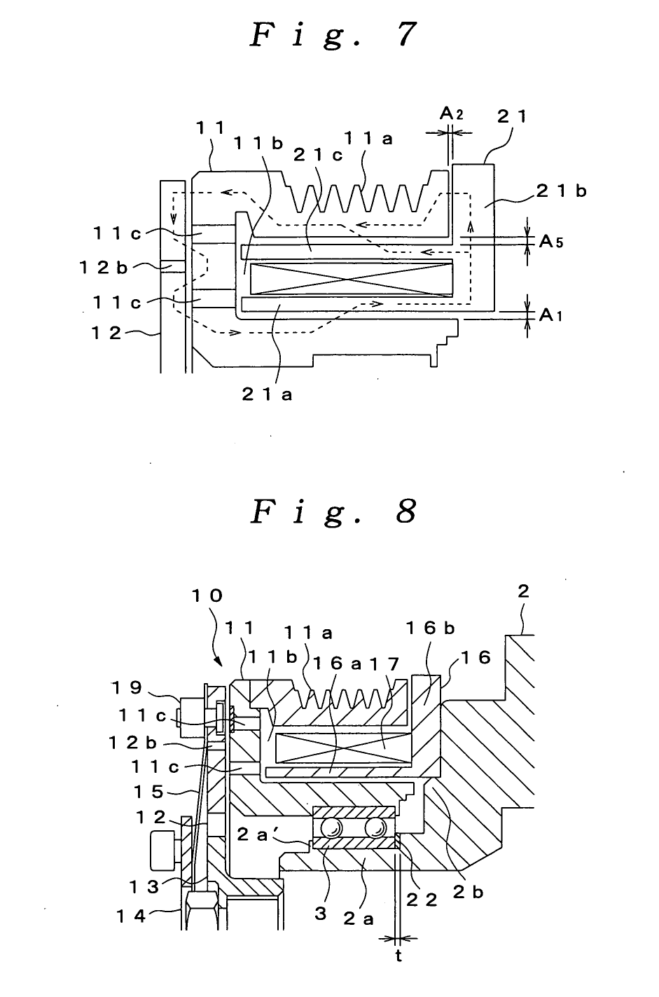

FIG. 8 is a side sectional view of an essential part of the electromagnetic clutch showing a fourth embodiment. The components equivalent to those in the above described embodiment are shown with the same reference numerals.

In this embodiment, a ring member 22 having a predetermined thickness dimension t in the axial direction is interposed between the end faces in the axial direction of the bearing 3 and the compressor body 2, a part of a support portion 2a of the compressor body 2 is deformed by caulking to be enlarged in the radial direction and this deformed portion 2a′ is locked by the bearing 3 so as to fix the bearing 3 to the compressor body 2. By this, the gap A2 between the opposite face portion 16b of the core ring 16 and the rotor 11 can be set by the thickness dimension t of the ring member 22, and even if a dimension error in the axial direction is generated between the support portion 2a of the compressor body 2 and the rotor 11, the gap A2 in the axial direction can be formed in the adequate size all the time by using the ring member 22 of the thickness dimension according to the dimension error.

The above described embodiment shows an example that the ring member 22 is applied to the construction of the first embodiment, but it can be also applied to the construction of the first and the second embodiments.

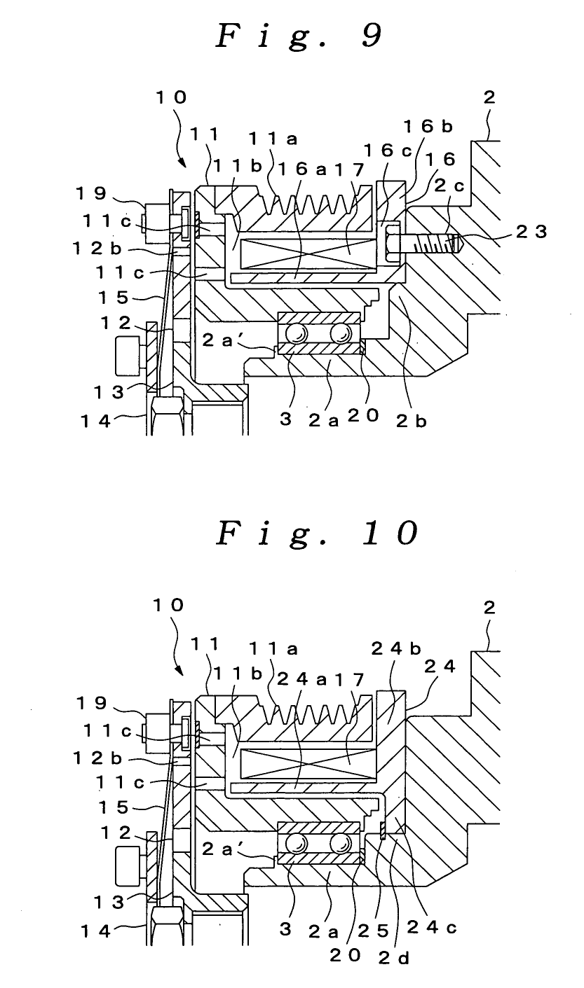

FIG. 9 is a side sectional view of an essential part of the electromagnetic clutch showing a fifth embodiment of the present invention. The components equivalent to those in the above described embodiment are shown with the same reference numerals.

In this embodiment, stepped holes 16c axially penetrating the opposite face portion 16b in the first embodiment at plural points in the circumferential direction are provided, and by screwing a bolt 23 inserted into each of the holes 16c into a screw hole 2c provided on one end face in the axial direction of the compressor body 2, the core ring 16 is fixed to the compressor body 2. By this, when fixing the core ring 16 and the compressor body 2 to each other, complicated bonding work such as welding is not required but assembling work can be performed extremely easily.

The above described embodiment shows an example that the fixed structure by the bolt 23 is applied to the construction of the fourth embodiment, but that can be also applied to the construction of the first to the third embodiments.

FIG. 10 is a side sectional view of an essential part of the electromagnetic clutch showing a sixth embodiment of the present invention. The components equivalent to those in the above described embodiment are shown with the same reference numerals.

A core ring 24 in this embodiment has, as with the above described embodiment, an inner circumferential face portion 24a opposed in the radial direction to the circumferential face inside in the radial direction of the recess portion 11b and an opposite face portion 24b opposed in the axial direction to the other end face in the axial direction of the pulley portion 11a of the rotor 11. Also, a flange portion 24c extending inward in the radial direction is provided on the other end side in the axial direction of the core ring 20.

In this embodiment, the core ring 24 is fixed to the compressor body 2 by engaging the flange portion 24c with the engagement portion 2b of the compressor body 2, by attaching a known snap ring 25 to the engagement portion 2b and locking the snap ring 25 by the flange portion 24c in the axial direction. By this, when fixing the core ring 16 and the compressor body 2 to each other, complicated bonding work such as welding is not required but assembling work can be performed extremely easily.

The above described embodiment shows an example that the fixed structure by the snap ring 25 is applied to the construction of the fourth embodiment, but that can be also applied to the construction of the first to the third embodiments.

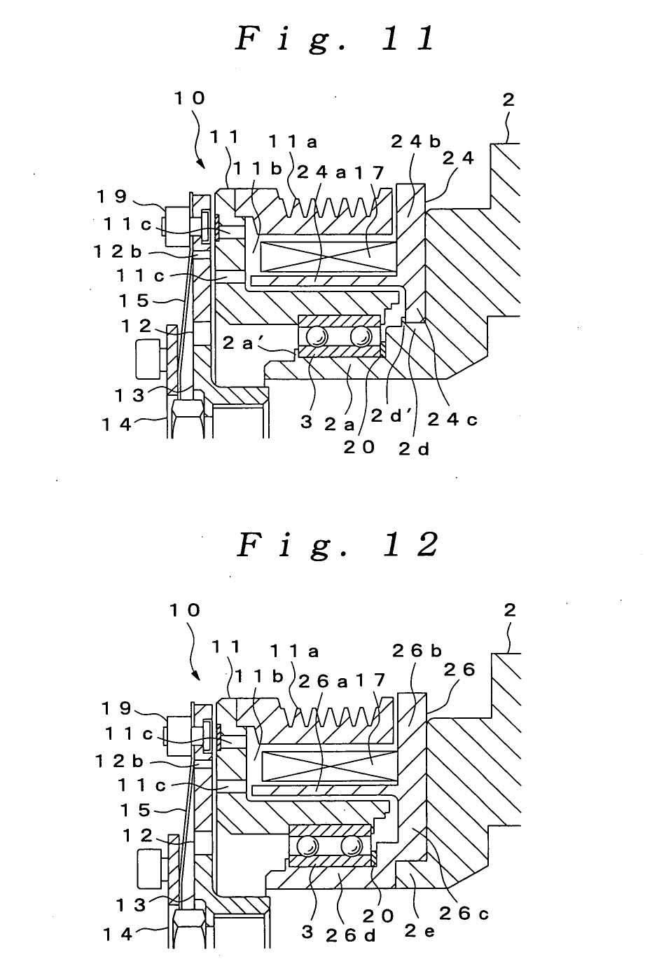

FIG. 11 is a side sectional view of an essential part of the electromagnetic clutch showing a seventh embodiment of the present invention. The components equivalent to those in the above described embodiment are shown with the same reference numerals.

In this embodiment, the engagement portion 2d is deformed by caulking to be enlarged in the radial direction and by locking this deformed portion 2d′ by the flange portion 16c, the core ring 16 is fixed to the compressor body 2. By this, when fixing the core ring 16 and the compressor body 2 to each other, complicated bonding work such as welding is not required but assembling work can be performed extremely easily.

The above described embodiment shows an example that the fixed structure by caulking is applied to the construction of the fourth embodiment, but that can be also applied to the construction of the first to the third embodiments.

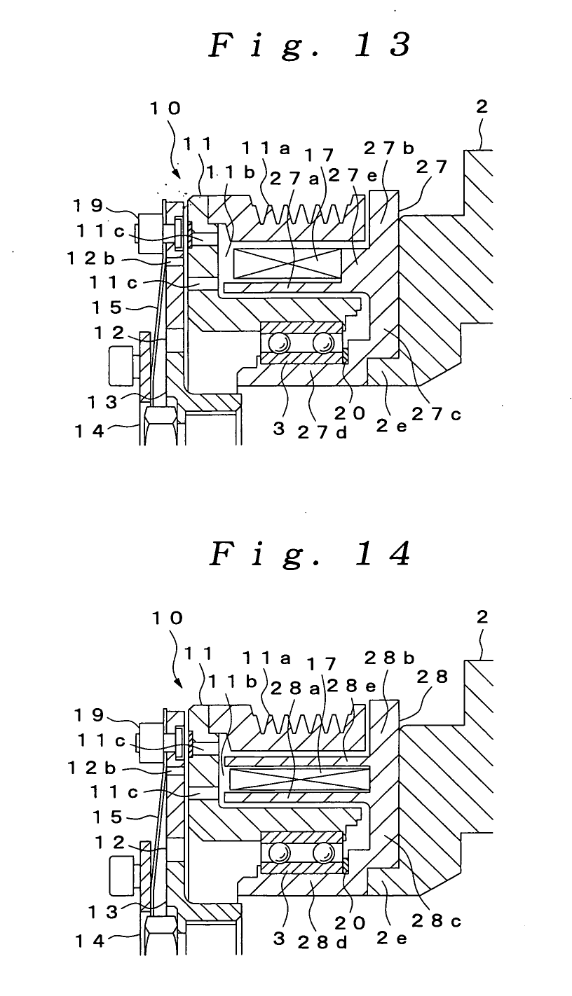

FIG. 12 is a side sectional view of an essential part of the electromagnetic clutch showing an eighth embodiment of the present invention. The components equivalent to those in the above described embodiment are shown with the same reference numerals.

A core ring 26 in this embodiment has, as with the above described embodiment, an inner circumferential face portion 26a opposed in the radial direction to the circumferential face inside in the radial direction of the recess portion 11b and an opposite face portion 26b opposed in the axial direction to the other end face in the axial direction of the pulley portion 11a of the rotor 11. A flange portion 26c extending inward in the radial direction is provided on the other end side in the axial direction of the core ring 26, and by engaging the flange portion 26c with the engagement portion 2c of the compressor body 2, movement of the core ring 26 in the radial direction is regulated. Also, the core ring 26 is integrally provided with a support portion 26d for supporting the rotor 11. The support portion 26d is formed in the cylindrical state extending from inside in the radial direction of the flange portion 26c toward the one end side in the axial direction, and the rotor 11 is rotatably supported by its outer circumferential face via the bearing 3.

According to this embodiment, since the support portion 26d for supporting the rotor 11 is integrally provided on the core ring 26, the core ring 26 can be formed coaxially with the support portion 26d, and the rotor 11 supported by the support portion 26d can be arranged on the same axial center with the core ring 26 without separate alignment. In this case, since the flange portion 26c of the core ring 26 is engaged with the engagement portion 2c of the compressor body 2 so that the movement in the radial direction is regulated, the core ring 26 is not displaced in the radial direction with respect to the compressor body 2, and the axial centers of the core ring 26 and the rotational axis 1 can be also aligned with each other with high accuracy.

FIG. 13 is a side sectional view of an essential part of the electromagnetic clutch showing a ninth embodiment of the present invention. The components equivalent to those in the above described embodiment are shown with the same reference numerals.

A core ring 27 in this embodiment has, as with the eighth embodiment, an inner circumferential face portion 27a opposed in the radial direction to the circumferential face inside in the radial direction of the recess portion 11b, a first opposite face portion 27b opposed in the axial direction to the other end face in the axial direction of the pulley portion 11a of the rotor 11, a flange portion 27c extending inward in the radial direction from the other end side in the axial direction of the core ring 20 and a support portion 27d for supporting the rotor 11. Also, the core ring 27 has, as with the second embodiment, a second opposite face portion 27e opposed in the radial direction to a part of the circumferential face outside in the radial direction of the recess portion 11b. By this, not only the flow of the magnetism in the axial direction from the first opposite face portion 27b to the rotor 11 but also the flow of the magnetism in the radial direction from the second opposite face portion 27e to the rotor 11 can be formed, by which the magnetic resistance can be further reduced.

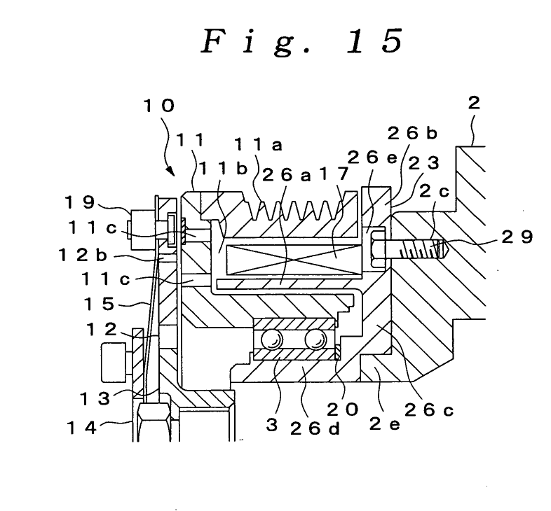

FIG. 14 is a side sectional view of an essential part of the electromagnetic clutch showing a tenth embodiment of the present invention. The components equivalent to those in the above described embodiment are shown with the same reference numerals.

A core ring 28 in this embodiment has, as with the eighth embodiment, an inner circumferential face portion 28a opposed in the radial direction to the circumferential face inside in the radial direction of the recess portion 11b, an opposite face portion 28b opposed in the axial direction to the other end face in the axial direction of the pulley portion 11a of the rotor 11, a flange portion 28c extending inward in the radial direction from the other end side in the axial direction of the core ring 28 and a support portion 28d for supporting the rotor 11. Also, the core ring 28 has, as with the second embodiment, an outer circumferential face portion 28e opposed in the radial direction to the circumferential face outside in the radial direction of the recess portion 11b. By this, as with the second embodiment, not only the flow of the magnetism in the axial direction from the opposite face portion 28b to the rotor 11 but also the flow of the magnetism in the radial direction from the outer circumferential face portion 28e to the rotor 11 can be formed, by which the magnetic resistance can be further reduced.

FIG. 15 is a side sectional view of an essential part of the electromagnetic clutch showing an eleventh embodiment of the present invention. The components equivalent to those in the above described embodiment are shown with the same reference numerals.

In this embodiment, stepped holes 26e axially penetrating the opposite face portion 26b in the eighth embodiment at plural points in the circumferential direction are provided, and by screwing a bolt 29 inserted into each of the holes 26e into the screw hole 2c provided on one end face in the axial direction of the compressor body 2, the core ring 26 is fixed to the compressor body 2. By this, when fixing the core ring 26 and the compressor body 2 to each other, complicated bonding work such as welding is not required but assembling work can be performed extremely easily.

The above described embodiment shows an example that the fixed structure by the bolt 29 is applied to the construction of the eighth embodiment, but that can be also applied to the construction of the ninth and the tenth embodiments.

Also, the above described embodiment shows an example that the core ring 26 is fixed to the compressor body 2 by the bolt 29, but the core ring 26 may be fixed to the compressor body 2 by deforming a predetermined portion of the compressor body 2 by caulking so as to enlarge it in the radial direction and locking it by the core ring 26 or by attaching a locking member to be locked by the core ring 26 to the compressor body 2.

What is claimed is:

1. An electromagnetic clutch for compressor provided with a core ring arranged coaxially with a rotational axis of a compressor, an electromagnetic coil provided on the core ring, an annular rotor rotatably supported on an outer circumferential face of a support portion extending in the axial direction from the compressor body via a bearing and formed surrounding the core ring from the radial direction, a pulley portion formed on an outer circumferential face side of the rotor, and an armature arranged opposite to one end face in the axial direction of the rotor and rotated integrally with the rotational axis of the compressor, in which a torque of the rotor is transmitted to the armature by attracting the armature to the one end face in the axial direction of the rotor by a magnetic force of the electromagnetic coil, comprising:
an opposite face portion provided on said core ring opposite to the other end face in the axial direction of the pulley portion with a gap through which magnetism can communicate; and
wherein the other end face of the pulley portion in the axial direction and the opposite face portion of the core ring are formed perpendicularly to the axial center of the rotor, respectively.

2. The electromagnetic clutch for compressor according to claim 1, wherein said core ring is formed so that only its inner circumferential face side is opposed in the radial direction to the rotor and the electromagnetic coil is arranged so that it is opposed in the radial direction to the rotor to the outer circumferential face side of the core ring.

3. The electromagnetic clutch for compressor according to claim 2, wherein said core ring is provided with an opposite face portion opposed in the radial direction to the rotor.

4. The electromagnetic clutch for compressor according to claim 1, wherein said core ring is formed so that its inner circumferential face side and the outer circumferential face side are opposed in the radial direction to the rotor, respectively, and the electromagnetic coil is arranged between the inner circumferential face side and the outer circumferential face side of the core ring.

5. The electromagnetic clutch for compressor according to claim 1, wherein a ring member having a predetermined thickness dimension in the axial direction of said rotor and axially interposed between the compressor body and the bearing is provided.

6. The electromagnetic clutch for compressor according to claim 1, wherein the other end side in the axial direction of said pulley portion is formed larger in the radial direction than a belt winding portion of the pulley portion.

7. The electromagnetic clutch for compressor according to claim 1, wherein said support portion is integrally provided on said core ring.

8. The electromagnetic clutch for compressor according to claim 1, wherein said core ring is engaged with the compressor body so that radial movement is regulated.

9. The electromagnetic clutch for compressor according to claim 1, wherein said core ring is fixed to the compressor body with a bolt.

10. The electromagnetic clutch for compressor according to claim 1, wherein said core ring is fixed to the compressor body by attaching a lock member for locking on the core ring side onto the compressor body side.

11. The electromagnetic clutch for compressor according to claim 1, wherein said core ring is fixed to the compressor body by partially deforming the compressor body and by locking it on the core ring side.
